(19) United States
(12) Patent Application Publication
(10) Pub. No.: US 2015/0009271 A1
(43) Pub. Date: Jan. 8, 2015

(54) System and Method of Thermal Printing Security Features

(71) Applicant: CTPG Operating, LLC, Ithaca, NY (US)

(72) Inventors: Robert Delaney, Ithaca, NY (US); Kyle Turner, Lake Forest, IL (US)

(73) Assignee: CTPG Operating, LLC, Ithaca, NY (US)

(21) Appl. No.: 14/179,958

(22) Filed: Feb. 13, 2014

Related U.S. Application Data
(60) Provisional application No. 61/842,538, filed on Jul. 3, 2013.

(51) Int. Cl. B41J 2/32

(52) U.S. Cl. CPC B41J 2/32
USPC 347/211

(57) ABSTRACT

The present invention relates to thermal printers and, more particularly, to direct thermal printers structured, configured, and/or programmed to print security features such as pantographs, watermarks, and microprinting on a thermal media substrate.

### RELATED APPLICATION DATA

The present application claims the benefit of U.S. provisional patent application No. 61/842,538, filed Jul. 3, 2013, and is hereby incorporated by reference in its entirety.

### BACKGROUND OF THE INVENTION

1. Field of the Invention

The present invention relates to thermal printers and, more particularly, to direct thermal printers structured, configured, and/or programmed to print security features such as pantographs, watermarks, and microprinting on a thermal media substrate.

2. Description of the Related Art

Security printing relates to the practice of manufacturing media substrate with certain security indicia/features to prevent forgery and counterfeiting of items such as passports, checks, and prescription pads. As should be understood by those of ordinary skill in the art, security printing can include, for example, the inclusion of watermarks, UV coatings, security fibers, microprinting, holograms, phosphorescent inks, and pantographs (e.g., “void”) etc. in the manufacture of the media substrate. This media is typically very expensive as many of these features require special processes to create the preprinted media.

Additionally, pantographs have been printed with both laser and ink jet printers.

Description of the Related Art Section Disclaimer: To the extent that specific patents/publications/products are discussed above in this Description of the Related Art Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Description of the Related Art Section and/or throughout the application, the descriptions/disclosures of which are all hereby incorporated by reference into this document in their respective entirety(ies).

### SUMMARY OF THE INVENTION

The present invention recognizes that there are potential problems and/or disadvantages with the conventional technology used in the manufacturing of media substrate with certain security indicia/features. First, the manufacturer, distributor/seller, and user of preprinted security media must take steps to secure it from theft as a blank piece of security media is very valuable to a counterfeiter. To a counterfeiter, the blank security media is currency. Second, with laser printers, a toner source/cartridge must be changed periodically when the toner runs out. The toner is relatively expensive, and the loading process can be difficult and messy. Third, inkjet printers require an ink source/cartridge replacement when the print quality gets too light. This consumable item is very expensive. Also, the ink can smear at times which can ruin a pantographic image. Various embodiments of the present invention may be advantageous in that they may solve or reduce one or more of the potential problems and/or disadvantages discussed above.

Various embodiments of the present invention may exhibit one or more of the following objects, features and/or advantages:

It is therefore a principal object and advantage of the present invention to provide a thermal printer that is structured, configured, and/or programmed to print security features such as pantographs, watermarks, microprinting verification grids, validation marks, color, uv and/or IR marks, unique barcodes, serial numbers, anti-copying marks such as an Eurion mark, any combination thereof, and any other security patter as should be understood by those of skill in the art, on a thermal media substrate.

It is another object and advantage of the present invention to provide a method to print security features on thermal sensitive layer of regular thermal media substrate. With the ability to add these features in the thermal sensitive layer, the media can be less expensive for a security application and there is no need to store the media in a secure location to guard against theft.

It is a further object and advantage of the present invention to provide a method to print security features on demand on the thermal sensitive layer of regular thermal media substrate. By printing security features on demand with a direct thermal printer, they can be changed more often than what is done on pre-printed media (per communication with an external computer). This will make it harder for counterfeiters to consistently duplicate the security features.

Thermal printing has advantages over the above-referenced conventional technologies used to impart security features. Thermal printing has nothing extra to load other than the paper roll. This paper roll is extremely easy to replace and can be done in seconds. Thermal printing is more energy efficient than laser printing and thermal printers are smaller than laser printers. Thermal printers have fewer moving parts than inkjet printers and as a result, thermal printers have better reliability.

In accordance with the foregoing objects and advantages, an embodiment of the present invention is directed to a thermal printer that is structured, configured, and/or programmed to print security features such as pantographs, watermarks, and microprinting on a thermal media substrate that can include, but is not limited to, (1) a memory that can store at least one security feature and preferably, a plurality of security features, and (2) firmware that can be programmed to print the at least one security feature, and preferably, the plurality of security features on demand that are stored in the memory, and to merge the security feature(s) with variable data (such as receipt data, check data, financial data, identification data (birth certificate, pallet, container), contract data, ownership data (deeds, titles), legal data (trusts etc.), government data, prescription data, medical/healthcare data, public safety data (e.g., elevator inspections, health inspections), permit data (hunting licenses), ticket data, or label data (part identification), for example, as should be understood by those of skill in the art) preferably in real time depending on the particular application. The firmware can be updated by a computer that is in wired or wireless communication with the firmware within the computer. Additional security features can be transmitted to the memory by a computer that is in wired or wireless communication with the memory. The wireless communication/transmission can be over a network, which can be any suitable wired or wireless network capable of transmitting communication, including but not limited to a telephone network, Internet, Intranet, local area network, Ethernet, online communication, offline communications, wireless communications and/or similar communications means. Further, this data can be encrypted as needed based on the sensitivity of the data or the location the printer, for example. The computer can be located in the same room, in a different room in the same building, and/or in a completely different building and location from the thermal printer. A user using the computer (or a different computer) can instruct the thermal printer to print a particular pre-stored security feature (e.g., a particular pantograph loaded in memory of the thermal printer) on a thermal media substrate, and to merge the particular security feature with variable data.

In accordance with an additional embodiment of the present invention, there is provided a method of printing security features in the thermal sensitive layer of thermal media, which includes the implementation of one or more algorithms that can be programmed into the firmware. One of the algorithms can be the dot history algorithm. Per the dot history algorithm, the firmware controls the energy profile for each thermal element to assure none get too hot during the printing process. If a thermal element gets too hot, the dots in the pattern can become elongated and printing a pantograph or other secure dot patterns become impossible. For printing secure dot patterns, the length and width of each dot should preferably be equivalent.

Another algorithm can be the paper feed algorithm. The vertical paper feed increment is preferably controlled precisely to work in harmony with the dot history algorithm to form square dots.

Furthermore, the thermal head preferably should have characteristics which allow it to heat and cool quickly for a fast thermal cycle. A fast thermal cycle for each dot allows dots to be formed square on the thermal media.

Additionally, the thermal layer of the media preferably should be extremely smooth and must contain no voids. The thermal sensitivity of the layer preferably should be high so that once the dot energy is applied the dot is formed very quickly. The media preferably can be top coated with various coatings to protect from moisture and sunlight contamination. Other coatings may be added to enhance security such as phosphorescent and UV coatings.

### BRIEF DESCRIPTION OF THE DRAWINGS

The present invention will be more fully understood and appreciated by reading the following Detailed Description in conjunction with the accompanying drawings, in which:

FIG. 1 is a system architecture diagram of a thermal printer that is structured, configured, and/or programmed to print security features on a thermal media substrate with various communication links to a computer, according to an embodiment of the present invention.

FIG. 2 is a more detailed system architecture diagram of the thermal printer shown in FIG. 1, according to an embodiment of the present invention.

FIG. 3 is a photograph of a thermal media substrate without variable data that was produced by the thermal printer of an embodiment of the present invention.

FIG. 4 is a photocopy of the photograph shown in FIG. 3.

FIG. 5 is a flowchart showing a process for printing security patterns in the thermal sensitive layer of thermal media using direct thermal printing, according to an embodiment of the present invention.

FIG. 6 is a drawing showing dot positions used for a typical dot history algorithm on a section of a thermal print head, according to an embodiment of the present invention.

FIG. 7 is a drawing showing dot positions used for an improved dot history algorithm on a section of a thermal print head, according to an embodiment of the present invention.

### DETAILED DESCRIPTION

The present invention will be more fully understood and appreciated by reading the following Detailed Description in conjunction with the accompanying drawings, wherein like reference numerals refer to like components.

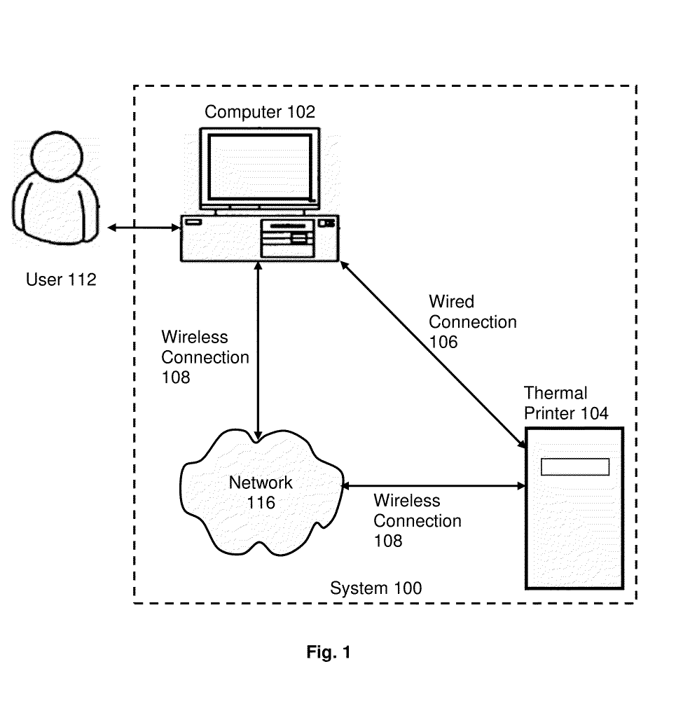

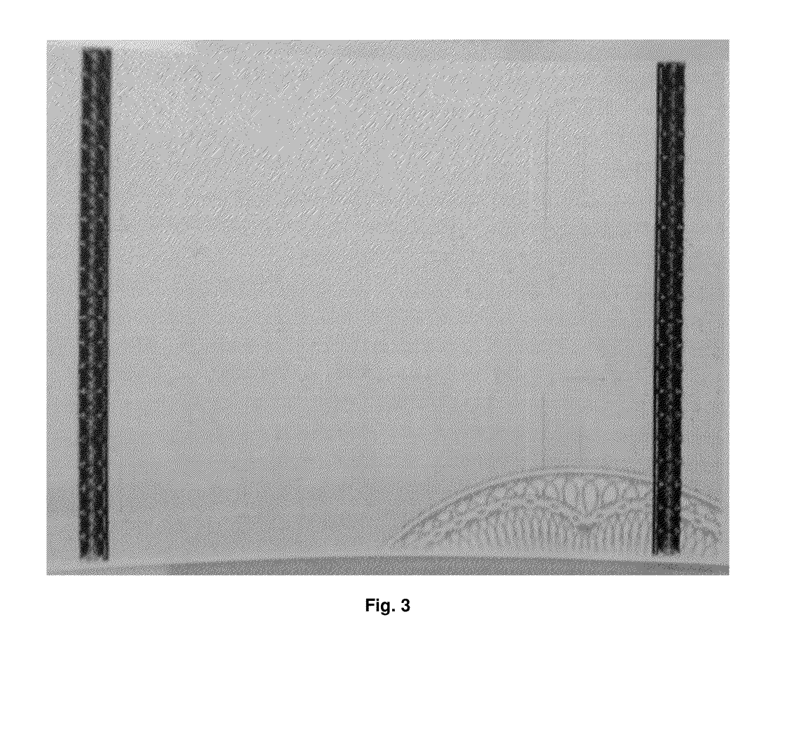

Turning to FIG. 1, a system architecture diagram of a thermal printer 104 that is structured, configured, and/or programmed to print security features such as pantographs, watermarks, and microprinting on a thermal media substrate on a thermal media substrate (not shown), and can have various communication links to a computer 102, according to an embodiment of the present invention is shown. Communication connections between the computer 102 and the thermal printer 104, including a wired connection 106 and a wireless connection 108, are shown. A network 116 is also shown. A user 112 using the computer 102 (or a different computer) can instruct the thermal printer 104 to print a particular pre-stored security feature (e.g., a particular pantograph loaded in memory of the thermal printer) on a thermal media substrate (see FIG. 3), and to merge the particular security feature with variable data.

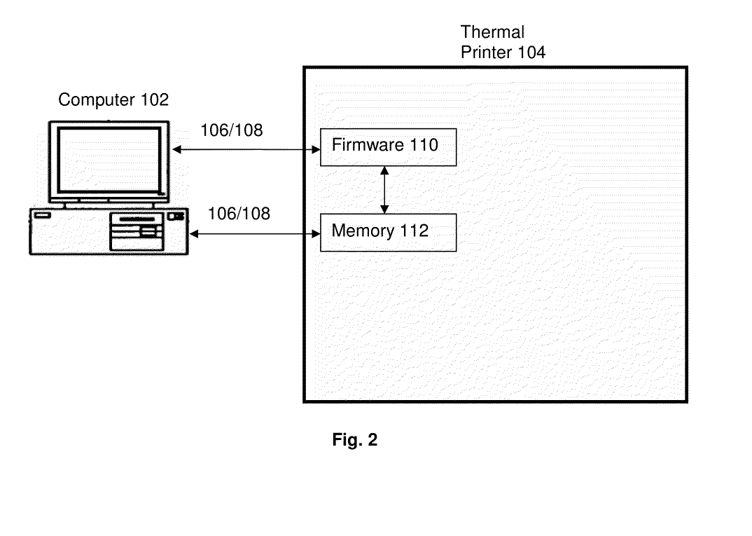

FIG. 2 shows a more detailed system architecture diagram of the thermal printer 104 shown in FIG. 1, according to an embodiment of the present invention. The thermal printer 104 can include a (1) memory 112 that can store at least one security feature and preferably, a plurality of security features, and (2) firmware 110 that can be programmed to print the at least one security feature, and preferably, the plurality of security features on demand that are stored in the memory, and to merge the security feature(s) with variable data (such as receipt, check, or prescription data, for example, as should be understood by those of skill in the art) preferably in real time depending on the particular application. The firmware 110 and memory 112 can have wired 106/wireless 108 communication connections to the computer 102. In an alternative embodiment, the security feature (such as a pantograph) can be stored, updated, etc. on the computer 102.

FIG. 3 is a photograph of a thermal media substrate without variable data that as produced by the thermal printer of an embodiment of the present invention. This substrate was printed without any variable data. However, this substrate can also be printed with variable data, as described herein.

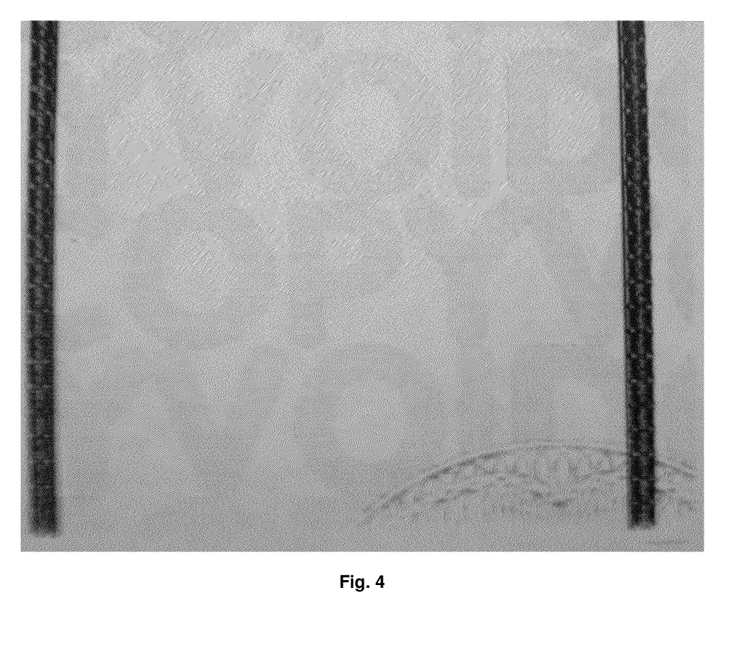

The receipt shown in FIG. 3 was printed with a “void pantograph,” which is not shown in the original thermal media substrate shown in FIG. 3. However, the “void pantograph” is shown in FIG. 4, which is a photocopy of the photograph shown in FIG. 3. Thus, the “void pantograph” manufactured into the thermal media substrate of FIG. 3 prevents the ability to make counterfeits of the thermal media substrate of FIG. 3 through the process of photocopying.

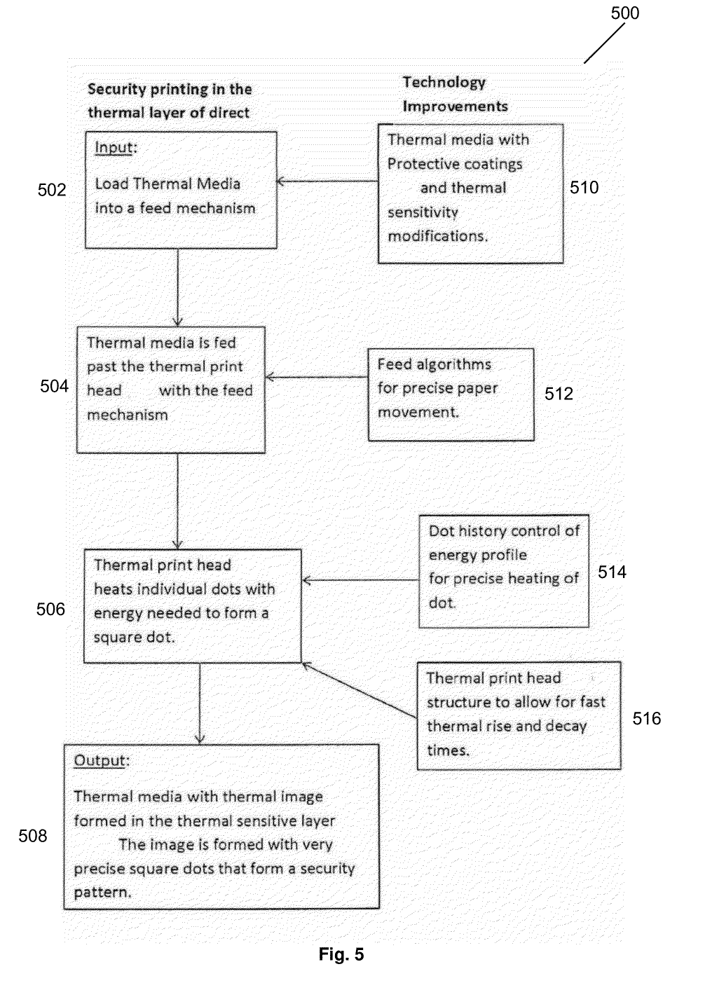

In accordance with an embodiment of the present invention, there is provided a method of printing security features 500 in the thermal sensitive layer of thermal media by the thermal printer 104 of an embodiment of the present invention. Turning to FIG. 5, a process for printing security patterns on the thermal sensitive layer of direct thermal media is provided. One aspect of the present invention is a dot history algorithm. Per the dot history algorithm, the firmware 110 controls the energy profile for each dot to assure none get too hot during the printing process. A typical dot history algorithm is configured to “look” at how the dot has been used in the previous two lines printed. It will also look at how the two adjacent dots were used on the previous line. In a first step 502, the thermal media is loaded into the feed mechanism. A technology improvement 510 can include providing thermal media with protective coatings and thermal sensitivity modifications. In a second step 504, thermal media is fed pas the thermal print head with the feed mechanism. A technology improvement 512 can include feed algorithms for precise paper movement. In a third step 506, the thermal print head heats individual dots with energy needed to form a square dot. A technology improvement 514 can include dot history control of energy profile for precise heating of the dot. Another technology improvement 516 can include a thermal print head structure to allow for fast thermal rise and decay times. In a fourth step 508, thermal media with a thermal image is formed in the thermal sensitive layer. The image is preferably formed with very precise square dots that form a security pattern.

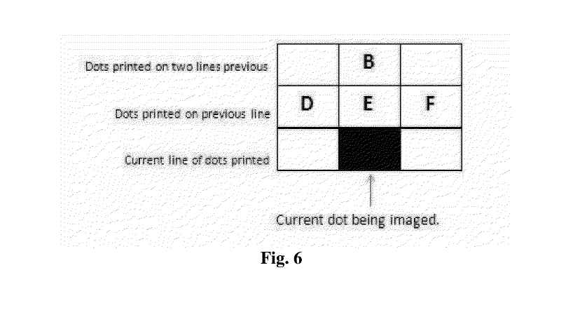

As shown in FIG. 6, a typical dot history algorithm uses the energy profile for dot positions B, D, E, and F to determine the energy profile needed to burn the current dot. If a thermal element gets too hot, the dots in the pattern become elongated and printing a pantograph or other secure dot pattern becomes impossible. When printing secure dot patterns, the length and width of each dot preferably should be equal. Imaging square dots for pantograph patterns requires an improved dot history algorithm.

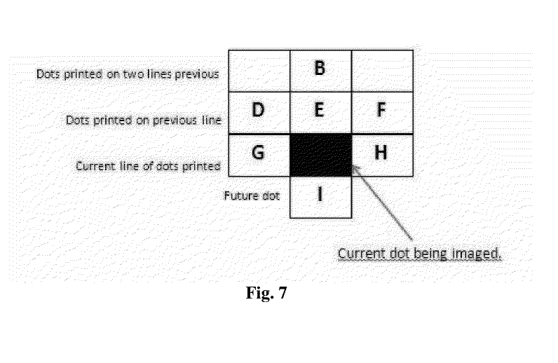

In an improved dot history algorithm, the energy profile for the current dot in its two previous lines printed and the energy profiles for the adjacent dots in the current line and the previous line are considered. Also, it considers how the current dot will be used on the next line printed (future). As shown in FIG. 7, an improved dot history algorithm considers the energy used for positions B, D, E, F, G, H, and Ito determine the energy needed to burn the current dot, in accordance with an embodiment of the present invention. By using more dot history, the improved dot history algorithm is able to better image each dot so that it remains square when printing pantographic patterns.

Another aspect of the present invention is the feed mechanism of the thermal printer 104. This mechanism stores and feeds the thermal media inside the printer. The paper feed algorithm controls the feed mechanism as it feeds the thermal media past the thermal print head. The vertical paper feed increment of the feed mechanism should preferably be controlled precisely to work with the dot history algorithm to form square dots. The feed algorithm should be configured to move the paper faster or slower depending on the length that the dot history algorithm required for imaging the current dot.

An improvement to the feed algorithm can increase the accuracy of the vertical feed increment and help in the formation of square dots. The improvement is obtained through microstepping control of the paper feed stepper motor. Microstepping is the control process that runs the stepper motor as smoothly as possible. Due to the nature of step motors, their rotation is not entirely smooth. A microstepper controller is a driver that sends pulses to the motor in an ideal sinusoidal waveform for smooth rotation. Two sinewaves that are ninety degrees out of phase is the perfect driver for a smooth motor. The two sinewaves work together to keep the motor in smooth transition from one pole to the other. When the current increases in one coil, it decreases in the other, resulting in smooth step advancing and continuous torque output at each position. The results for the feed mechanism using microstepping are very accurate and stable vertical feed increments for the printer. This will help make the formation of square dots possible.

Another aspect of the present invention is the thermal media. The thermal media can be made of various layers and coatings. The substrate layer contains the base paper and can contain security features such as security fibers and security marks. The substrate layer should preferably be extremely smooth so that all of the thermal elements in the thermal print head come in good contact the substrate to aid in the development of square dots for security printing. The thermal sensitive layer of the media should preferably also be extremely smooth and free of voids. The thermal sensitivity of this layer should preferably be high so that once the dot energy is applied the dot is formed very quickly. The media should preferably have protective coatings to resist fading do to exposure to UV, moisture, oils, or grease. Also, the media can have security coatings which can contain phosphorescent, IR or UV inks.

A “module,” as may be used herein, can include, among other things, the identification of specific functionality represented by specific computer software code of a software program. A software program may contain code representing one or more modules, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, completely or partly on the thermal printer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While several embodiments of the invention have been discussed, it will be appreciated by those skilled in the art that various modifications and variations of the present invention are possible. Such modifications do not depart from the spirit and scope of the present invention.

What is claimed is:

1. A thermal printer structured or programmed to print at least a first security feature on a substrate comprising:
a memory configured to store said first security feature; and
a non-transitory computer-readable storage medium having program code for printing said first security feature on the substrate.

2. The thermal printer of claim 1, further structured or programmed to merge said first security feature with variable data on the substrate.

3. The thermal printer of claim 2, further structured or programmed to merge said first security feature with variable data on the substrate in real time.

4. The thermal printer of claim 1, wherein said first security feature comprises a security feature selected from the group consisting of pantographs, watermarks, microprinting, verification grids, validation marks, color, uv marks, IR marks, barcodes, serial numbers, anti-copying marks, and any combination thereof.

5. The thermal printer of claim 2, wherein said variable data comprises variable data selected from the group consisting of receipt data, check data, financial data, identification data, contract data, ownership data, legal data, government data, prescription data, medical/healthcare data, public safety data, permit data, ticket data, and label data.

6. The thermal printer of claim 1, wherein said memory is configured to store a second security feature.

7. The thermal printer of claim 6, wherein said non-transitory computer-readable storage medium has program code for printing said second security feature on the substrate.

8. The thermal printer of claim 1, wherein said substrate comprises a thermal media substrate.

9. A method of thermally printing at least a first security feature on a substrate comprising the steps of:
providing a thermal printer comprising a memory configured to store said first security feature, and a non-transitory computer-readable storage medium having program code for printing said first security feature on the substrate; and
printing said first security feature on the substrate using said thermal printer.

10. The method of claim 9, further comprising the step of merging said first security feature with variable data on the substrate.

11. The method of claim 9, further comprising the step of transmitting a second security feature to said memory.

12. The method of claim 11, wherein the step of transmitting is from a situs outside said thermal printer.

13. The method of claim 12, wherein the step of transmitting further comprises wireless transmission.

14. The method of claim 13, further comprising the step of storing said second security feature in said memory.

15. The method of claim 12, further comprising the step of updating program code in said non-transitory computer-readable storage medium for printing said second security feature on the substrate.
